(19) United States
(12) Patent Application Publication
(10) Pub. No.: US 2019/0246603 A1
(43) Pub. Date: Aug. 15, 2019

(54) HORSE BOOTS FOR PROTECTING A PART OF THE LEG OF A HORSE

(71) Applicant: AMAHORSE TRADING S.R.L., San Giustino (PERUGIA) (IT)

(72) Inventor: Mauro BENETTI, Lonato del Garda (BRESCIA) (IT)

(73) Assignee: AMAHORSE TRADING S.R.L., San Giustino (PERUGIA) (IT)

(21) Appl. No.: 16/329,227

(22) PCT Filed: Aug. 24, 2017
(86) PCT No.: PCT/IB2017/055103

§ 371 Date: Feb. 28, 2019

(30) Foreign Application Priority Data
Sep. 2, 2016 (IT) 202016000089387

(51) Int. Cl. A01K 13/00; A01L 3/00; A01L 5/00

(52) U.S. Cl. CPC A01K 13/007; A01L 5/00; A01L 3/00

(57) ABSTRACT

Protective boots for protecting a portion of a leg of a horse, such as the shin or ankle, are provided which include a protective element suitable for surrounding at least partially the leg portion, and fastening elements suitable for connecting two opposite sides of the protective element so as to tightly secure the protective element to the leg portion. The fastening elements can include at least one strap having a proximal portion secured to one of the opposite sides and at least one distal portion, and at least one rigid attachment element integral to the other of the opposite sides. The straps can be made as a single body of elastic material.

The object of the present invention is a protective boot applicable to a leg of a horse, in particular the horse's shin and ankle. In particular, the invention relates to an innovative fastening system for the boot protecting a horse's leg.

Known protective boots are usually fastened to the animal's leg by means of a plurality of laces or elastic straps that connect the two ends of the protective element that surrounds the leg.

Laces or elastic straps fasten the protective element in various ways. For example, Velcro elements, buckles, loops and interlocking couplings are used.

In all cases, fastening and removing the protective boot involves the fastening and release of several laces or straps and, especially in certain embodiments, these operations require a certain amount of time and dexterity.

If, on the one hand, Velcro fastening is the fastest fastening system among the ones listed, on the other, it has the drawback of being the most subject to wear, losing its efficiency over time.

WO2010023584 A2 describes a shin boot for horses wherein the fastening means comprise an elastic strap having one end secured to one side of the protective element and one free end to which an attachment plate is fixed. Rearward-facing hook teeth extend from the attachment plate. An attachment counter-plate is fixed to the other side of the protective element and includes attachment seats suitable to be engaged by the hook teeth.

Although this embodiment makes the closing and opening operations of the protective boot quick and easy, it entails a certain complexity in the manufacturing phase.

The object of the present invention is to provide a protective boot which at least partially overcomes the drawbacks referred to above with reference to the prior art.

In particular, the object of the present invention is to provide a protective boot having a particularly quick and secure fastening (and release) system and which at the same time is made of a small number of components and is therefore simple and economic to manufacture.

Such objects are achieved by means of a protective boot in accordance with claim 1.

Further features and advantages of the protective boot according to the invention will become evident from the description provided hereinafter of preferred embodiments thereof, given for indicative and non-limitative purposes, with reference to the accompanying figures, wherein:

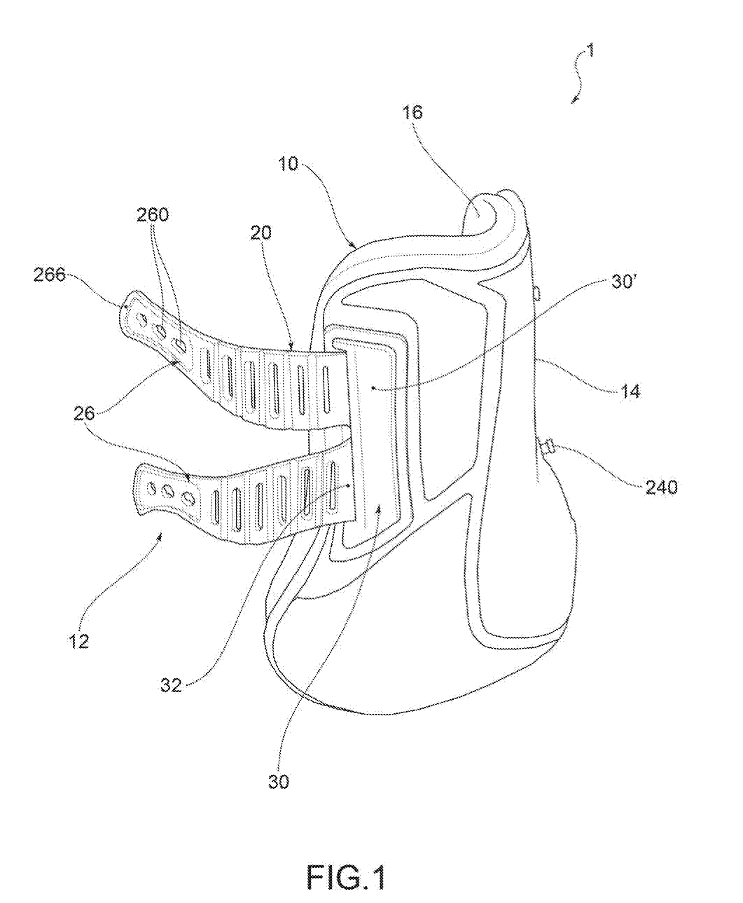

FIG. 1 is a front perspective view of the protective boot according to the invention in one embodiment and in an open configuration;

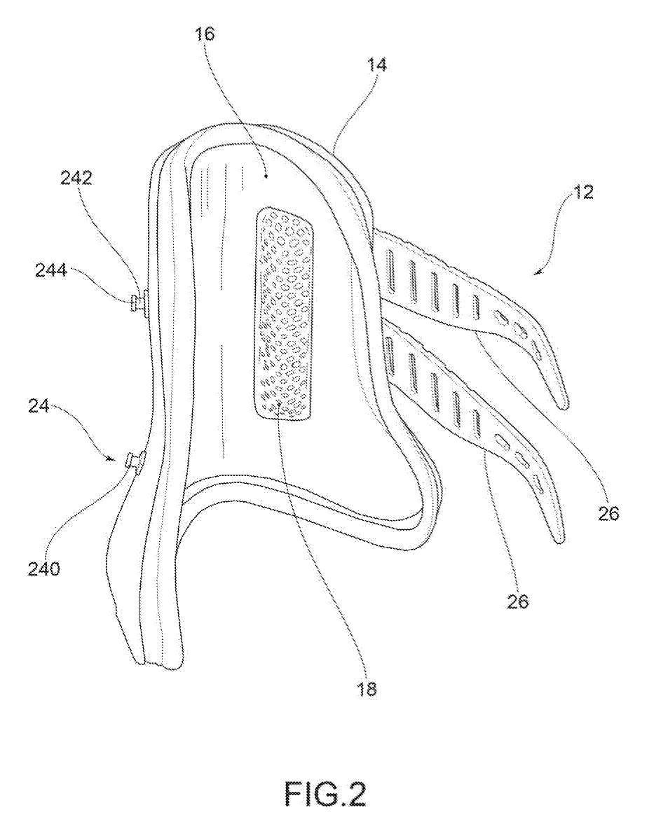

FIG. 2 is a rear perspective view of the protective boot of FIG. 1;

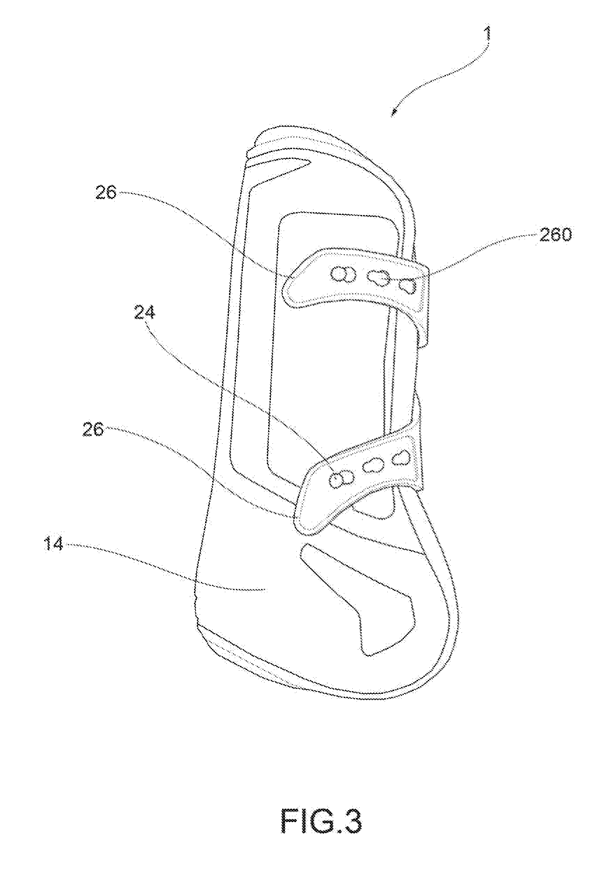

FIG. 3 is a side view of the closed configuration of the protective boot;

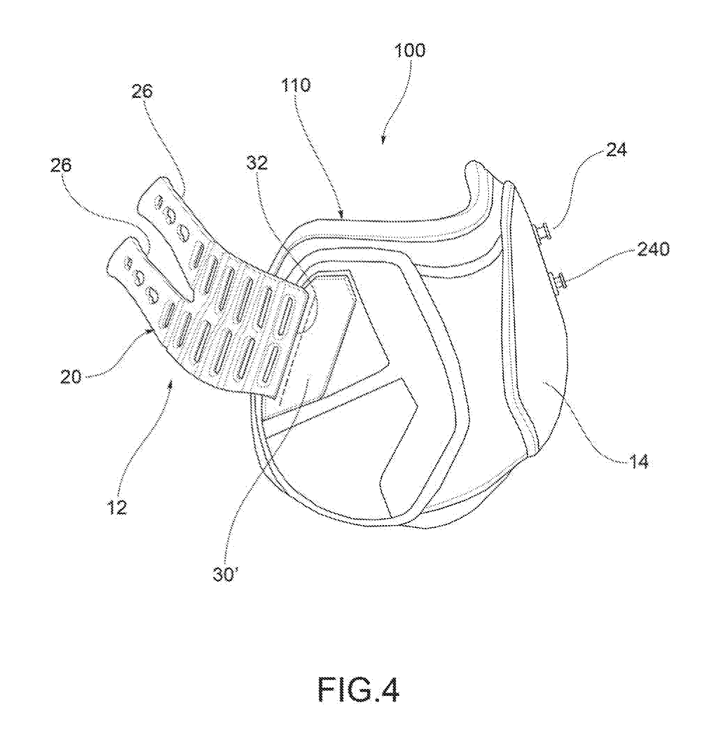

FIG. 4 is a front perspective view of the protective boot according to the invention in another embodiment and in an open configuration; and

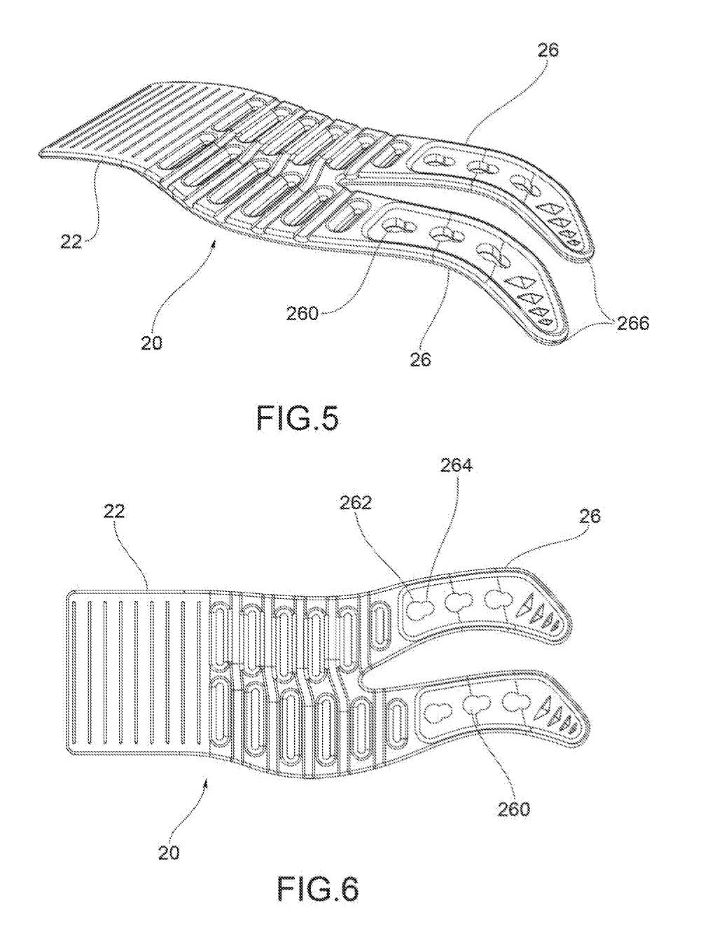

FIGS. 5 and 6 are a perspective view and a plan view, respectively, of the single strap of a protective boot according to the invention.

With reference to the above figures, protective boots applicable to a leg of a horse according to the invention are indicated at 1; 100. In particular, FIGS. 1-3 illustrate a protective boot 1, also known as a “shin boot”, applicable to the horse's shin; FIG. 4 is a protective boot 100 for the horse's ankle.

In the following description, elements common to the different embodiments of the protective boot, or equivalent thereof, will be indicated with the same numerical references.

The protective boot 1; 100 comprises a protective element 10; 110 suitable to surround a part of a horse's leg, such as the shin or ankle.

The protective boot 1; 100 also comprises fastening means 12 suitable to connect two opposing sides of the protective element 10; 110 so as to tightly secure the element protecting the leg.

The protective element 10; 110, has, in cross-section, a substantially “C” shape and is shaped so as to follow the morphology of the part of the leg to which it is to be applied.

In accordance with one embodiment, the protective element 10; 110 comprises an outer shell 14 made of a rigid or semi-rigid material, for example a plastic material, and a softer inner lining 16 that is suitable to come in contact with the animal's leg.

In one embodiment, strips or pads 18 or a silicone gel are applied to the inner liner 16, which have a shock absorbing function and therefore improve the comfort of the animal.

According to the invention, the fastening means 12 comprise at least one strap 20 having a proximal portion 22 secured to a side opposite the protective element 10; 110 and at least one distal portion 26. The strap 20 is made in a single body made of elastic material, for example a thermoplastic polyurethane-based material. An example of such material, suitable for use due to its excellent mechanical and chemical properties, resistance to wear and, in particular, to rupture and tension, is Elastollan® SP 9322, marketed by BASF Polyurethanes GmbH.

The fastening means 12 further comprise at least one rigid attachment element 24 integral with the other one on the opposite side.

The strap 20 has a distal portion 26 engageable/disengageable from the rigid attachment element 24 when the strap 20 is subjected to tension.

In one embodiment, the distal portion 26 is suitable to be engaged/disengaged from the rigid attachment element 24 according to different lengths of the strap 20. In other words, the strap 20 has an elasticity such that it may be elongated within an elongation range between a minimum value corresponding to a tensile force on the rigid attachment element 24 which is still sufficient to provide a safe fastening of the protective element around the leg of the horse, and a maximum value beyond which the strap undergoes permanent deformation. This permissible elongation range is such as to allow a single protective boot to cover more than one size of horse.

In one embodiment, the rigid attachment element 24 is a pin 240 extending from the outer surface of the protective element 10; 110 near the respective side. For example, the pin 240 is fixed to the outer shell 14. At least one keyhole 260 is made in the distal portion 26 of the strap, suitable for the pin 240 to pass therethrough.

In one embodiment, each pin 240 has a shank 242 and a head 244 having a diameter greater than that of the shank 242. Each keyhole 260 has a proximal portion 262 having a first diameter substantially equal to the diameter of the head 244 of the pin 240, and a distal portion 264 having a second diameter substantially equal to that of the shank 242 of the pin 240. Therefore, due to the flange made by the head 242 of the pin 240 with respect to the shank, and the fact that the strap 20 is tensioned on the pin 240, an accidental release of the strap 20 from the respective pin 240 is avoided.

In one embodiment, a row of keyholes 260 aligned in the direction of extension of the strap 20 is made in each distal portion 26 of the strap 20.

In one embodiment, the proximal portion 22 of the strap 20 is fixed to the outer shell 14 or to the inner lining 16, for example by stitching. It should be noted for this purpose that, in one embodiment, the strap 20 has a flattened shape, that is, it has a particularly reduced thickness. For example, the strap thickness may vary between 1 and 4 mm.

In one embodiment, a pocket 30 is formed in the outer shell 14, or between the outer shell 14 and the inner liner 16, wherein the proximal portion 22 of the strap 20 is inserted and fixed.

In particular, the strap 20 exits from a lateral slot 32 of such pocket 30. In one embodiment, the lateral slot 32 has substantially the same dimensions as the cross-section of the strap (i.e., width and thickness) so as to prevent dirt or water from penetrating into the pocket 30.

In one embodiment, the proximal portion 22 of the strap 20 is fixed, for example by stitching, to a closure plate 30′ of the pocket 30. The plate 30′ may be formed in one piece with the outer shell 14 or subsequently fixed to it, for example by stitching.

In one embodiment, the proximal portion 22 of the strap 20 is further secured to the pocket 30 by adhesive.

In one embodiment, the fastening means 12 comprise at least two rigid attachment elements 24 spaced along a direction substantially parallel to that of the opposite sides of the protective element 10; 110. Such rigid attachment elements 24 are engageable by at least one strap 20 having a single proximal portion 22 and at least two distal portions 26 substantially parallel to each other extending from the proximal portion 22. Each distal portion 26 is engageable/disengageable by a respective attachment element 24.

In particular, in one embodiment/the proximal portion 22 extends from the proximal end of the strap 20 to the lateral slot 32 of the pocket 30. Thus, the strap 20 is firmly secured to the protective element 10; 110 and the realization of the outer shell 14 is simplified since a single pocket 30 is formed even if there are more than one coupling portions 24, 26.

Furthermore, also in this case, the cross section of the single proximal portion 22 fully engages the lateral slot 32, preventing dirt or water from entering the pocket 30.

It should be noted that the realization of two or more distal portions 26 that bifurcate from a single proximal portion 22 of the strap makes it possible to differentiate the closing force exerted by the strap 20 on the attachment elements 24 as a function, for example, of the shape of the horse's leg.

In one embodiment, each distal portion 26 of the strap 20 terminates with a gripping tongue 266 which allows the user to hold the strap 20 while leaving the keyholes 260 free.

To the embodiments of the protective boot 1; 100 described above, those skilled in the act may, to satisfy contingent needs, make modifications, adaptations and replacements of some elements with others that are functionally equivalent, without departing from the scope of the following claims. Each of the features described as belonging to a possible embodiment may be implemented independently by the other described embodiments.

1-15. (canceled)

16. A protective boot for a portion of a horse's leg comprising a protective element suitable for at least partially surrounding the leg portion and fastening elements suitable for connecting two opposite sides of the protective element so as to tightly secure the protective element to the leg portion, wherein said fastening elements comprise at least one strap having a proximal portion secured to one of said opposite sides and at least one distal portion and at least one rigid attachment element integral to the other of said opposite sides, the strap being made as a single body of elastic material, each distal portion being engageable/disengageable by a respective rigid attachment element when the strap is subjected to tension.

17. The protective boot of claim 16, wherein said distal portion is suitable for being engaged/disengaged by said rigid attachment element according to different lengths of the strap.

18. The protective boot of claim 16, wherein said rigid attachment element is a pin extending from the outer surface of the protective element near the respective side, and wherein at least one keyhole is made in said distal portion, suitable for said pin to pass through.

19. The protective boot of claim 18, wherein each pin has a shank and a head having a diameter greater than said shank, and wherein each keyhole has a proximal portion having a first diameter substantially equal to the diameter of the head, and a distal portion having a second diameter substantially equal to that of the shank.

20. The protective boot of claim 16, wherein the protective element comprises an inner lining suitable for coming into contact with the leg portion which comprises a soft material and an outer shell applied to said inner lining comprising rigid or semi-rigid material.

21. The protective boot of claim 20, wherein the proximal portion of the strap is fixed to the outer shell or to the inner lining, for example by stitching.

22. The protective boot of claim 20, wherein in said outer shell, or between the outer shell and the inner lining, a pocket is formed wherein the proximal portion of the strap is inserted and fixed.

23. The protective boot of claim 22, wherein the proximal portion of the strap is fixed to a closure plate of said pocket.

24. The protective boot of claim 22, wherein the strap extends from a lateral slot of said pocket, said lateral slot having substantially the same dimensions as the cross-section of the strap.

25. The protective boot of claim 16 comprising at least two rigid attachment elements spaced along a direction substantially parallel to that of the opposite sides of the protective element, and at least one strap having a single proximal portion and at least two distal portions substantially parallel to each other extending from said proximal portion each distal portion being engageable/disengageable by a respective attachment element.

26. The protective boot of claim 24, wherein said single proximal portion extends from the distal end of the strap to at least the lateral slot of the pocket.

27. The protective boot of claim 16, wherein each distal portion of the strap ends with a gripping tongue.

28. The protective boot of claim 16 comprising an inner lining on which strips of a silicone gel are applied.

29. The protective boot of claim 16, wherein the protective element is shaped to surround the shin of a horse.

30. The protective boot of claim 16, wherein the protective element is shaped to surround the ankle of a horse.
